(19) United States
(12) Patent Application Publication
(10) Pub. No.: US 2026/0179977 A1
(43) Pub. Date: Jun. 25, 2026

(54) COMPOSITE POWDER, METHOD FOR MANUFACTURING COMPOSITE POWDER, GAS DIFFUSION LAYER, MEMBRANE ELECTRODE ASSEMBLY, AND FUEL CELL

(71) Applicant: Panasonic Intellectual Property Management Co., Ltd., Osaka (JP)

(72) Inventors: Takeshi KOIWASAKI, Osaka (JP); Ryutaro KUNIOKA, Osaka (JP); Hiroki MARUYAMA, Osaka (JP)

(21) Appl. No.: 19/536,625

(22) Filed: Feb. 11, 2026

Related U.S. Application Data
(63) Continuation of application No. PCT/JP2024/036401, filed on Oct. 11, 2024.

(30) Foreign Application Priority Data
Oct. 13, 2023 (JP) 2023-177739

(51) Int. Cl. H01M 8/0273; H01M 8/0234; H01M 8/10; H01M 8/1004; H01M 8/1007; H01M 8/2457

(52) U.S. Cl. CPC H01M 8/0273; H01M 8/0234; H01M 8/1004; H01M 8/1007; H01M 8/2457; H01M 2008/1095

(57) ABSTRACT

A method for manufacturing a composite powder, the method includes: stirring and mixing a polymer resin and at least one or more of fibers and particles with a dispersion solvent to obtain a mixed solution of the polymer resin and at least one or more of the fibers and the particles; spraying the mixed solution in a form of droplets into a chamber whose inside is cooled to a temperature lower than a melting point of the dispersion solvent to obtain a frozen composite powder in which the droplets are frozen; and sublimating the dispersion solvent contained in the frozen composite powder to obtain a dried composite powder.

### CROSS REFERENCE TO RELATED APPLICATION

This application claims priorities of Japanese Patent Application No. 2023-177739 filed on Oct. 13, 2023 and PCT Application No. PCT/JP2024/036401 filed on Oct. 11, 2024, the contents of which are incorporated herein by reference.

### BACKGROUND OF THE INVENTION

### 1. Field of the Invention

The present disclosure relates to a composite powder obtained by combining a polymer resin, particles, and fibers, a method for manufacturing the composite powder, and a gas diffusion layer, a membrane electrode assembly, and a fuel cell using the composite powder and the method.

### 2. Description of the Related Art

The gas diffusion layer has gas permeability and gas diffusibility, and is used, for example, in a fuel cell. In a polymer electrolyte fuel cell as an example of a fuel cell, one surface of a polymer electrolyte membrane having hydrogen ion conductivity is exposed to a fuel gas such as hydrogen, and the other surface is exposed to oxygen, and water is synthesized by a chemical reaction through the electrolyte membrane, thereby electrically extracting reaction energy generated at that time.

A unit cell of a polymer electrolyte fuel cell includes a membrane electrode assembly (hereinafter, referred to as MEA) and a pair of conductive separators disposed on both surfaces of the MEA. The MEA includes a polymer electrolyte membrane having hydrogen ion conductivity and a pair of electrode layers sandwiching the electrolyte membrane. The pair of electrode layers includes a catalyst layer which is formed on both surfaces of the polymer electrolyte membrane and contains a carbon powder carrying a platinum group catalyst as a main component, and a gas diffusion layer which is formed on the catalyst layer and has a current collecting action, gas permeability, and water repellency.

The gas diffusion layer in the MEA uniformly supplies the gas supplied from the separator to the catalyst layer. The gas diffusion layer also functions as a conductive path of electrons between the catalyst layer and the separator. Furthermore, the gas diffusion layer is required to have high water repellency so that excess moisture generated by the battery reaction in the catalyst layer is quickly removed and discharged out of the system from the MEA, and pores of the gas diffusion layer are not blocked by generated water.

Therefore, a gas diffusion layer in which an MPL (microporous layer) for managing produced water is formed on porous carbon paper or carbon felt using carbon fiber as a base material is generally used. The carbon paper or the carbon felt is subjected to a water-repellent treatment by being impregnated with a resin having high water repellency. Further, the MPL is composed of conductive particles such as carbon black and a resin having high water repellency, and plays a role of quickly discharging excess moisture generated in the catalyst layer from the MEA to the outside of the system and preventing scattering of moisture more than necessary.

For example, Japanese Patent Application Laid-Open No. H06-316784 as Patent Document 1 discloses that a solution obtained by mixing PTFE and conductive particles is spray-dried to manufacture a mixed powder, and the mixed powder is formed into a sheet to form a gas diffusion layer.

However, since the mixed powder of PTFE and conductive particles described in Patent Document 1 is granulated by spray drying, fiberization of PTFE proceeds due to temperature rise and shearing. In addition, since shrinkage and aggregation occur during heating and drying, only a powder having a small void can be manufactured. Furthermore, in the gas diffusion layer prepared using the mixed powder of PTFE and conductive particles described in Patent Document 1, since the fiberization of PTFE inside the mixed powder is advanced, PTFE for connecting the powders is insufficient, and the strength of the film is reduced. In addition, since the void of the mixed powder is small, only a film having a small void can be prepared. Therefore, in a fuel cell using a gas diffusion layer having a small void prepared from a conventional mixed powder, water is likely to be retained in pores in the carbon fiber base particularly in a high current density region where a large amount of generated water is generated at the time of power generation, and gas diffusibility may be inhibited. In addition, a gas diffusion layer having a small film strength prepared from a conventional mixed powder has low durability, and may be broken in long-term operation.

### SUMMARY

The present disclosure is intended to solve the above-mentioned problems, and one non-limiting and exemplary embodiments provides a composite powder from which a gas diffusion layer having sufficient gas permeability and water dischargeability when used in the gas diffusion layer is obtained.

In one general aspect, the techniques disclosed here feature: a composite powder includes:
a polymer resin; and
at least one or more of fibers and particles,
wherein an average porosity of the composite powder is 50 vol % or more and 98 vol % or less.

In another general aspect, the techniques disclosed here feature: a gas diffusion layer includes a porous membrane containing the composite powder.

In another general aspect, the techniques disclosed here feature: a membrane electrode assembly includes:
the gas diffusion layer;
a pair of electrodes; and
an electrolyte membrane.

In another general aspect, the techniques disclosed here feature: a fuel cell includes:
the membrane electrode assembly; and
a current collector plate.

In another general aspect, the techniques disclosed here feature: a method for manufacturing a composite powder, the method includes:
stirring and mixing a polymer resin and at least one or more of fibers and particles with a dispersion solvent to obtain a mixed solution of the polymer resin and at least one or more of the fibers and the particles;
spraying the mixed solution in a form of droplets into a chamber whose inside is cooled to a temperature lower than a melting point of the dispersion solvent to obtain a frozen composite powder in which the droplets are frozen; and
sublimating the dispersion solvent contained in the frozen composite powder to obtain a dried composite powder.

In another general aspect, the techniques disclosed here feature: a method for manufacturing a composite powder, the method includes:
stirring and mixing a polymer resin and at least one or more of fibers and particles with a dispersion solvent to obtain a kneaded product of the polymer resin and at least one or more of fibers and particles;
freezing the kneaded product to obtain a frozen kneaded product;
pulverizing the frozen kneaded product to obtain a frozen composite powder; and
removing the dispersion solvent from the frozen composite powder to obtain a composite powder.

In another general aspect, the techniques disclosed here feature: a method for manufacturing a composite powder, the method comprising:
stirring and mixing a polymer resin and at least one or more of fibers and particles with a dispersion solvent to obtain a kneaded product of the polymer resin and at least one or more of fibers and particles;
freezing the kneaded product to obtain a frozen kneaded product;
mixing the frozen kneaded product and the polymer resin to obtain a frozen mixture;
pulverizing the frozen mixture to obtain a frozen composite powder; and
removing the dispersion solvent from the frozen composite powder to obtain a composite powder.

In another general aspect, the techniques disclosed here feature: a method for manufacturing a gas diffusion layer, includes:
preparing the composite powder according to claim 1; and
rolling the composite powder with a roll to form a sheet, thereby obtaining a gas diffusion layer including the sheet.

The composite powder according to the present disclosure can manufacture a gas diffusion layer having sufficient gas permeability and water dischargeability while keeping the inside of the MEA in a water-containing state when used in the gas diffusion layer.

Additional benefits and advantages of the disclosed embodiments will be apparent from the specification and figures. The benefits and/or advantages may be individually provided by the various embodiments and features of the specification and drawings disclosure, and need not all be provided in order to obtain one or more of the same.

### BRIEF DESCRIPTION OF DRAWINGS

The present disclosure will become readily understood from the following description of non-limiting and exemplary embodiments thereof made with reference to the accompanying drawings, in which like parts are designated by like reference numeral and in which:

FIG. 1 is an example of a flowchart of a method for manufacturing a composite powder by a freeze granulation method according to Example 1;

FIG. 2 is a schematic cross-sectional view showing a cross-sectional configuration of a spray freezing granulation device;

FIG. 3 is an example of a flowchart of a method for manufacturing a composite powder by a freeze pulverization method according to Example 2;

FIG. 4 is an example of a flowchart of a method for manufacturing a composite powder by a freeze pulverization method according to Example 3;

FIG. 5 is an example of a flowchart of a method for manufacturing a composite powder by a freeze pulverization method according to Example 4;

FIG. 6 is an SEM image of a composite powder according to Example 1;

FIG. 7 is an SEM image of a composite powder according to Reference Example 1;

FIG. 8 is an SEM image showing PTFE particles that are not formed into fibers in the composite powder according to Example 1;

FIG. 9 is an SEM image showing PTFE particles that are not formed into fibers in the composite powder according to Reference Example 1;

FIG. 10 is a diagram showing a pore distribution of a composite powder according to Example 1-2;

FIG. 11 is a diagram showing a pore distribution of a composite powder according to Reference Example 1;

FIG. 12 is a schematic cross-sectional view showing a cross-sectional structure of a polymer electrolyte fuel cell according to the first embodiment; and

FIG. 13 is a schematic perspective view showing a configuration of a polymer electrolyte fuel cell stack according to the first embodiment.

### DETAILED DESCRIPTION

An outline of aspects of the present disclosure is as follows.

A composite powder according to a first aspect. includes:
a polymer resin; and
at least one or more of fibers and particles,
wherein an average porosity of the composite powder is 50 vol % or more and 98 vol % or less.

With the above configuration, a porous membrane having a large porosity can be prepared by using a powder having a large porosity.

In the composite powder according to a second aspect in addition to the first aspect, an average value of sphericity may be expressed as (A−B)/A, where a difference (A−B) between a maximum radius A of a concentric circumscribed circle of the composite powder and a minimum radius B of a concentric inscribed circle of the composite powder is divided by the maximum radius A to obtain the sphericity of the composite powder,
wherein the concentric circumscribed circle is a maximum geometric circle, the concentric inscribed circle is a minimum geometric circle, when a distance between two concentric geometric circles of the circumscribed circle and the inscribed circle is minimized when the composite powder is sandwiched between the two concentric geometric circles in a cross section, the average value of the sphericity may satisfy Expression (1) below:

$$( A - B ) / A \leq 0.5 . \qquad Expression ( 1 )$$

With the above configuration, since the composite powder is a spherical powder, the composite powder has high fluidity, and it is possible to prepare a film having high uniformity when forming the film.

In the composite powder according to a third aspect in addition to the first or second aspect, the polymer resin may have a degree of fiberization of 80% or less.

Polymer resins such as polytetrafluoroethylene (PTFE) are known to be formed into fibers by application of a shear force. When the PTFE in the powder is further converted into fibers, the PTFE fiber connecting the powders is insufficient when a film is prepared from the powder, and the strength of the film decreases. Therefore, according to the above configuration, by suppressing the degree of fiberization of the polymer resin to 80% or less, a film having high strength can be prepared.

In the composite powder according to a fourth aspect in addition to any one of the first to third aspects, the composite powder may have a degree of aggregation of 30% or less.

In the composite powder according to a fifth aspect in addition to any one of the first to fourth aspects, the composite powder may have a deformation strength of 1 kPa or more and 60 kPa or less.

In the composite powder according to a sixth aspect in addition to any one of the first to fifth aspects, the composite powder may have, inside the composite powder, pores with a pore radius of 0.055 μm or more and 0.4 μm or less having a pore volume of 0.60 mL/g or more in a Log differential pore volume graph measured by a mercury intrusion method.

According to the above configuration, by preparing a film from a powder having a large void and a controlled pore radius, a film having a large void and a controlled pore radius can be prepared.

In the composite powder according to a seventh aspect in addition to any one of the first to sixth aspects, the polymer resin may contain polytetrafluoroethylene.

In the composite powder according to an eighth aspect in addition to seventh aspect, the composite powder may include 1 wt % or more and 40 wt % or less of the polytetrafluoroethylene.

In the composite powder according to a ninth aspect in addition to any one of the first to eighth aspects, the particles may be conductive particles, and the fibers may be conductive fibers.

In the composite powder according to a tenth aspect in addition to ninth aspect, the composite powder may include:
5 wt % or more and less than 35 wt % of the conductive particles; and
35 wt % or more and 80 wt % or less of the conductive fibers.

In the composite powder according to an eleventh aspect in addition to any one of the first to tenth aspects, the composite powder has an average particle diameter of 1 μm or more and 1000 μm or less.

A gas diffusion layer according to a twelfth aspect, includes a porous membrane containing the composite powder according to any one of first to eleventh aspects.

In the gas diffusion layer according to a thirteenth aspect in addition to twelfth aspect, the gas diffusion layer may have pores with a pore radius of 0.055 μm or more and 0.4 μm or less having a pore volume of 0.60 mL/g or more in a Log differential pore volume graph measured by a mercury intrusion method.

In the gas diffusion layer according to a thirteenth aspect in addition to twelfth or thirteenth aspect, the gas diffusion layer may have pores having two peaks in a Log differential pore volume graph measured by a mercury intrusion method, and the gas diffusion layer has a pore radius of 0.055 μm or more and 0.4 μm or less having a pore volume of 0.60 mL/g or more and a pore radius of 0.4 μm or more and 10 μm or less having a pore volume of 0.10 mL/g or more.

In the gas diffusion layer according to a fourteenth aspect in addition to any one of twelfth to fourteenth aspects, porosity of pores having a diameter of 10 μm or more may be 0.5% or less.

A membrane electrode assembly according to a sixteenth aspect includes:
the gas diffusion layer according to any one of twelfth to fifteenth aspects;
a pair of electrodes; and
an electrolyte membrane.

A fuel cell according to a seventeenth aspect includes:
the membrane electrode assembly according to sixteenth aspect; and
a current collector plate.

According to the above configuration, by using a gas diffusion layer having a high film strength, a large void, and a controlled pore radius in a fuel cell, it is possible to control introduction of a reaction gas and discharge of generated water due to a reaction, to improve output, and to enhance durability.

A method for manufacturing a composite powder according to a eighteenth aspect, the method includes:
stirring and mixing a polymer resin and at least one or more of fibers and particles with a dispersion solvent to obtain a mixed solution of the polymer resin and at least one or more of the fibers and the particles;
spraying the mixed solution in a form of droplets into a chamber whose inside is cooled to a temperature lower than a melting point of the dispersion solvent to obtain a composite powder in which the droplets are frozen; and
sublimating the dispersion solvent contained in the frozen composite powder to obtain a dried composite powder.

With the above configuration, the frozen composite powder can be obtained by spraying the mixed solution into the cooling chamber and freezing the mixed solution. Thereafter, by sublimating the dispersion solvent contained in the frozen composite powder, the dispersion solvent can be removed while maintaining the space where the dispersion solvent existed, and a powder having a large void can be manufactured. In addition, since no shear force is applied to the polymer resin, fiberization of the polymer resin can be suppressed.

In the method for manufacturing a composite powder according to nineteenth aspect in addition to the eighteenth aspect, the polymer resin may contain polytetrafluoroethylene.

In the method for manufacturing a composite powder according to twenties aspect in addition to the eighteenth or nineteenth aspect, the method further includes a step of further heating the dried composite powder at 100° C. (CelsiusDegree) or more and 400° C. (CelsiusDegree) or less.

According to the above configuration, polytetrafluoroethylene (PTFE) softens and easily turns into fibers by heating. At the same time, the mixed particles and fibers are expanded by heating, so that the fiberization of PTFE can be promoted.

A method for manufacturing a composite powder according to a twenty-first aspect, the method includes:
stirring and mixing a polymer resin and at least one or more of fibers and particles with a dispersion solvent to obtain a kneaded product of the polymer resin and at least one or more of fibers and particles;
freezing the kneaded product to obtain a frozen kneaded product;
pulverizing the frozen kneaded product to obtain a frozen composite powder; and
removing the dispersion solvent from the frozen composite powder to obtain a composite powder.

According to the above configuration, by pulverizing the moisture in the kneaded product in a frozen state, it is possible to perform pulverization without crushing voids in which the frozen moisture exists. Therefore, particles having large voids can be manufactured. In addition, since no shear force is applied to the polymer resin, fiberization of the polymer resin can be suppressed, and the shape can be maintained.

In the method for manufacturing a composite powder according to a twenty-second aspect in addition to the twenty-first aspect, a water content of the kneaded product may be 20 to 80%.

In the method for manufacturing a composite powder according to a twenty-third aspect in addition to the twenty-first or twenty-second aspect, a temperature in the course of the pulverizating may be −150° C. (CelsiusDegree) to −10° C. (CelsiusDegree).

In the method for manufacturing a composite powder according to a twenty-fourth aspect in addition to any one of the twenty-first to twenty-third aspects, in the course of removing the dispersion solvent, the dispersion solvent contained in the frozen composite powder may be sublimated to obtain a dried composite powder.

In the method for manufacturing a composite powder according to a twenty-fifth aspect in addition to any one of the twenty-first to twenty-fourth aspects, in the course of removing the dispersion solvent, heating is further performed at 100° C. (CelsiusDegree) or more and 400° C. (CelsiusDegree) or less.

In the method for manufacturing a composite powder according to a twenty-sixth aspect in addition to any one of the twenty-first to twenty-fifth aspects, the removing the dispersion solvent may be performed by a method of evaporating moisture by heating under atmospheric pressure.

In the method for manufacturing a composite powder according to a twenty-seventh aspect in addition to twenty-sixth aspect, in the course of removing the dispersion solvent, a drying temperature may be 100° C. (CelsiusDegree) or more and 400° C. (CelsiusDegree) or less.

A method for manufacturing a composite powder according to a twenty-eighth aspect, the method includes:
stirring and mixing a polymer resin and at least one or more of fibers and particles with a dispersion solvent to obtain a kneaded product of the polymer resin and at least one or more of fibers and particles;
freezing the kneaded product to obtain a frozen kneaded product;
mixing the frozen kneaded product and the polymer resin to obtain a frozen mixture;
pulverizing the frozen mixture to obtain a frozen composite powder; and
removing the dispersion solvent from the frozen composite powder to obtain a composite powder.

A method for manufacturing a gas diffusion layer according to a twenty-ninth aspect, includes:
preparing the composite powder according to any one of first to eleventh aspect;
and rolling the composite powder with a roll to form a sheet, thereby obtaining a gas diffusion layer including the sheet.

According to the above configuration, by rolling the composite powder between rolls and applying shear, PTFE that is not formed into fibers can be formed into a sheet to obtain a gas diffusion layer that is a free-standing film.

A method for manufacturing a gas diffusion layer according to thirtieth aspect, the method includes:
manufacturing a composite powder by using the method according to any one of eighteenth aspect, twenty-first aspect, and twenty-eighth aspect; and
rolling the composite powder with a roll to form a sheet, thereby obtaining a gas diffusion layer including the sheet.

A method for manufacturing a membrane electrode assembly according to thirty-first aspect, the method includes:
manufacturing a gas diffusion layer by using the method according to thirtieth aspect;
applying the gas diffusion layer, a pair of electrodes, and an electrolyte membrane to form a membrane electrode assembly.

A method for manufacturing a fuel cell according to thirty-second aspect, the method includes:
manufacturing a membrane electrode assembly by using the method according to thirty-first aspect; and
applying the membrane electrode assembly and a current collector plate to form a fuel cell.

Hereinafter, a composite powder, a method for manufacturing the composite powder, a gas diffusion layer, a membrane electrode assembly, and a fuel cell according to an embodiment of the present disclosure will be described in detail with reference to the accompanying drawings.

Note that each of the embodiments described below shows a comprehensive or specific example. Numerical values, shapes, materials, components, arrangement positions and connection modes of the components, steps, order of the steps, and the like shown in the following embodiments are merely examples, and are not intended to limit the present disclosure. Further, among the components in the following embodiments, components that are not described in independent claims indicating the highest concept are described as optional components. In the drawings, substantially the same components are denoted by the same reference numerals, and redundant description may be omitted or simplified.

In addition, various elements shown in the drawings are merely schematically shown for understanding the present disclosure, and dimensional ratios, appearances, and the like may be different from actual ones.

### First Embodiment

### <Composite Powder >

A composite powder according to a first embodiment contains a polymer resin and at least one or more of fibers and particles. In the first embodiment, for example, polytetrafluoroethylene (PTFE) as a polymer resin, carbon fibers as fibers, and carbon particles as particles are used. Although the type and composition will be described later, the combination of the polymer resin, the fibers, and the particles is not limited to the above example.

The average particle diameter of the composite powder is, for example, 1 μm or more and 1000 μm or less. Although it varies depending on the film to be formed and the porosity, it is desirable to make the film thickness smaller than the target film thickness. In addition, when the average particle diameter decreases, the cohesive force increases and the handleability decreases, and thus the average particle diameter is preferably 1 μm or more. A method for calculating the average particle diameter of the composite powder will be described. The average particle diameter of the composite powder can be measured using, for example, a particle diameter distribution measuring device MT3000II manufactured by Microtrac Corporation. The average particle diameter means a particle diameter at an integrated value of 50% (D50) in a particle size distribution obtained by a laser diffraction/scattering method. The particle diameter at the integrated value of 50% is a particle diameter when the number of particles is counted from the smallest particle size and reaches 50% of the total number of particles. In the laser diffraction/scattering method, the particle size can be measured by utilizing the fact that the light intensity distribution of diffracted and scattered light varies depending on the particle size when laser light is applied to the particle.

The average porosity of the composite powder is 50 vol % or more and 98 vol % or less. The average porosity refers to the volume ratio of voids in the particles. The pore size of submicron or smaller can be measured by a nitrogen gas adsorption method, but when the pore size is wide, the pore size can be measured by electron microscope observation, mercury intrusion method (JIS R1655 “Method for Measuring Pore Diameter Distribution of Molded Body by Mercury Injection Method of Fine Ceramics” derived from relationship between pressure and mercury volume when mercury is introduced into voids), or the like. The average porosity can be calculated by the following expression from the pore volume obtained by the mercury intrusion method and the true density of the material.

((pore volume×true density)/(1+pore volume×true density))×100[vol %]

However, the average porosity calculated above may also include voids between powders. Therefore, the molded body can be measured by molding the powder under a certain load.

In the first embodiment, the average porosity of the powder is calculated using a pore volume measured by a mercury intrusion method (JIS R1655). Regarding the filling of the powder, the powder in a state in which no load is applied is filled in a measurement container. The pore radius was calculated in a range of 0.001 μm to 100 μm. Since the calculation range of the pore radius may include voids between powders, the optimum range can be set depending on the particle diameter of the powder and the like. When the average porosity decreases, voids of a film to be formed also decrease, and therefore the average porosity is preferably 50 vol % or more. When the average porosity of the powder is too large, the powder cannot be formed, and therefore the average porosity is preferably 98 vol % or less.

In a cross section, when the composite powder is sandwiched between two concentric geometric circles of a circumscribed circle and an inscribed circle, a maximum radius A of a maximum geometric circle that is a concentric circumscribed circle of the composite powder and a minimum radius B of a minimum geometric circle that is a concentric inscribed circle of the composite powder when a distance between the two concentric geometric circles is minimized are calculated. In the composite powder, an average value of sphericity represented by (A−B)/A obtained by dividing a difference (AB) between the maximum radius A and the minimum radius B by the maximum radius A is 0.5 or less, and the composite powder satisfies Expression (1) below, and has a substantially spherical shape.

$$( A - B ) / A \leq 0.5 \qquad Expression ( 1 )$$

For the spherical shape, the sphericity represented by (A−B)/A can be calculated from the image of the electron microscope. An average value of the sphericity (A−B)/A of five or more samples of the composite powder was calculated excluding the powder broken by impact or the like after manufacture. When the spherical composite powder has an average value of sphericity satisfying the expression (1), high fluidity can be obtained and a uniform film can be formed.

The composite powder has a degree of fiberization of PTFE, which is a polymer resin, of 80% or less. It is more preferably 60% or less. Although PTFE is in the state of particles as a raw material, it can be made into fibers by applying shear to form a free-standing film. A method for calculating the degree of fiberization of the polymer resin of the composite powder will be described. The degree of fiberization of the polymer resin of the composite powder is calculated by phase separation of the EDX image measurement result using SEM. For example, phase separation can be performed using the software AZtec4.3 from Oxford Instrument.

The phase analysis will now be described. The EDX image measurement result has a spectrum for each pixel. By performing calculation processing on the spectrum of each pixel obtained by the EDX image measurement, it is possible to obtain a phase analysis image in which pixels having similar spectra are grouped. From this phase analysis image, the area ratio of each phase in the image visual field and the composition ratio by quantitative analysis of the spectrum can be calculated. In the first embodiment, first, focusing on fluorine (F) contained in polymer resin PTFE and carbon (C) contained in conductive particles and conductive fibers, which are carbon materials, grouping was performed into two phases of a CF phase based on fluorine (F) and a C phase based on carbon (C). Since the fibers of PTFE are so thin that it is difficult to observe them by SEM, and the amount of detection per area is small, the F concentration in the C-phase, which is mainly composed of C, correlates with the amount of PTFE fibers. The degree of fiberization was further calculated from Expression (2) below using the F concentration of the entire surface.

$$Degree of PTFE fiberization : ( C - phase area ratio \times C - phase F concentration ) / total F concentration \qquad Expression ( 2 )$$

When the fiberization of PTFE in the composite powder progresses, the PTFE fibers connecting the composite powders are insufficient when a film is prepared from the composite powder, and the strength of the film is reduced. Therefore, by suppressing the degree of fiberization of PTFE to 80% or less, a film having high strength can be prepared.

### <Degree of Aggregation >

The composite powder has a degree of aggregation of 30% or less. It is more preferably 20% or less. By lowering the aggregation (in other words, cohesion), the fluidity is improved, and clogging and variation can be suppressed when a film is prepared. A method for calculating the degree of aggregation of the composite powder will be described. The degree of aggregation of the composite powder can be measured by, for example, Powder Tester PT-X manufactured by Hosokawa Micron Corporation. When a certain vibration is applied to the powder smaller than the mesh opening of the sieve on the sieve, the powder aggregates with each other to form large particles, or the powder adheres to the mesh surface of the sieve and does not fall from the sieve. A numerical value of this phenomenon is the degree of aggregation. The degree of aggregation is calculated by the following procedure. First, from the average value (average bulk density) of the loose bulk density and the hard bulk density, the three types of sieves and the vibration time corresponding thereto are calculated.

The loose bulk density can be measured in a state where the powder is gently filled (for example, sieve mesh opening of 710 μm, frequency of 60 Hz, amplitude of 1.0 mm, time of 50 seconds) in the container with a vibration sieve. The hard bulk density of the powder can be measured after gently filling the container with the powder similarly to the loose bulk density and further tapping (for example, stroke of 18 mm, number of times of 50) the container.

The selection of the mesh openings of the three types of sieves used for the measurement of degree of aggregation is performed as follows. For example, in the case of a sample having an average bulk density of the powder of 0.4 to 0.9 g/cm³, three types of sieves with mesh openings of 75 μm, 150 μm, and 250 μm are used. In the case of a sample having an average bulk density of the powder of less than 0.4 g/cm³, three types of sieves with mesh openings of 150 μm, 250 μm, and 355 μm are used. Further, in the case of a sample having an average bulk density of the powder of more than 0.9 g/cm³, three types of sieves with mesh openings of 45 μm, 75 μm, and 150 μm are used. In any case, the sieve is selected so that the sample powder passes through the lowermost sieve. This time, for example, since the average bulk density of the powder is smaller than 0.4 g/cm³, three types of sieves with mesh openings of 150 μm, 250 μm, and 355 μm were selected.

The time T[s] for vibrating the sieve is calculated from the following expression from the average value (average bulk density) of the loose bulk density and the hard bulk density using Expression (3) below.

$$T = 20 + ( 1.6 - ρ ) / 0.016 \qquad Expression ( 3 )$$

ρ: average value of loose bulk density and hard bulk density (average bulk density)

The degree of aggregation is calculated as follows. First, sieves having three types of mesh openings are stacked from the bottom in ascending order of mesh openings. Next, a powder of w [g] (usually 2 g) is placed on the uppermost sieve, and vibration with an amplitude of 1 mm is applied to the sieve for a predetermined time calculated from the bulk density. Thereafter, the powder remaining on each sieve is weighed. The degree of aggregation is calculated from Expression (4) below.

$$Degree of Aggregation = ( w 1 + ( 3 / 5 ) w 2 + ( 1 / 5 ) w 3 ) \times 100 / w \qquad Expression ( 4 )$$

w: sample amount (for example, 2 g)
w1: residual amount on upper sieve (for example, opening size 350 μm)
w2: residual amount on middle sieve (for example, opening size 250 μm)
w3: residual amount on lower sieve (for example, opening size 150 μm)

### <Deformation Strength >

The composite powder has a deformation strength of 1 kPa or more and 60 kPa or less. The deformation strength is more preferably 5 kPa or more and 30 kPa or less. By reducing the deformation strength, a film can be formed with a weak force. If the deformation strength is too small, the powders adhere to each other before the film is formed, and a uniform film cannot be formed. A method for calculating the deformation strength of the composite powder will be described. The deformation strength of the composite powder can be measured by, for example, a microparticle crushing force measuring apparatus NS-A300 model manufactured by NANOSIES Co., Ltd. In the measurement of the deformation strength, one powder particle is picked up, force F is continuously applied to the particle, force F10% at a compressive displacement of 10% of an initial particle diameter of the particle is obtained, and deformation strength ˜10% represented by Expression (5) below is taken as the deformation strength.

$$σ 10 \% = F 10 \% / A \qquad Expression ( 5 )$$

σ10%: deformation strength against compressive displacement of 10% of particle diameter (Pa)
F10%: test force for compressive displacement of 10% of particle diameter (N)
A: representative area (area of equivalent circle obtained by particle diameter of particles measured before compression) (m²)

The particle diameter used for the data was measured for each particle from the image at the time of measurement using image analysis software (WinROOF). As the particle diameter used in the particle strength calculation, the diameter (length) of a particle sandwiched between planes where an indenter and a particle are attached is used.

The composite powder has pores with a pore radius of 0.055 μm or more and 0.4 μm or less having a pore volume of 0.60 mL/g or more in a Log differential pore volume graph measured by a mercury intrusion method (JIS R1655).

By manufacturing a gas diffusion layer by a manufacturing method described later using this composite powder, pores having a peak in a range of a pore radius of 0.055 μm or more and 0.4 μm or less can be formed in the gas diffusion layer 3.

### <Types of Conductive Particles 31, Conductive Fibers 32, and Polymer Resin 33>

As the conductive particles 31, for example, a carbon material such as carbon black, graphite, or activated carbon can be used. Among them, it is preferable to use carbon black having high conductivity and a large pore volume. As the carbon black, acetylene black, Ketjen black, furnace black, and Vulcan can be used. Among them, acetylene black having a small impurity amount or ketjen black having a large specific surface area and high conductivity is preferably used. In addition, fullerenes such as fullerene 60 may be used as the conductive particles.

In the size of the conductive particles, for example, D50 is 10 nm or more and 5 μm or less. Furthermore, for example, D50 may be 10 nm or more and 500 nm or less, and may be 10 nm or more and 100 nm or less. When the conductive particles are carbon black, for example, the primary particle diameter may be 10 nm or more and 500 nm or less and 10 nm or more and 100 nm or less, and the size of the aggregate (primary aggregate) may be, for example, 100 nm or more and 500 nm or less. When the conductive particles are graphite or activated carbon, for example, D50 is 1 μm or more and 5 μm or less.

The conductive fibers 32 contribute to improvement of conductivity and improvement of mechanical strength of the gas diffusion layer 3. The material of the conductive fibers 32 is not particularly limited, but for example, carbon fibers such as carbon nanotubes can be used.

The average fiber diameter of the conductive fibers 32 is preferably 50 nm or more and 300 nm or less. When the average fiber diameter of the conductive fibers 32 is 50 nm or more, it is possible to more effectively contribute to improvement of conductivity of the gas diffusion layer 3 and to further enhance mechanical strength of the gas diffusion layer 3. Thus, the gas diffusion layer 3 can have sufficient strength as a free-standing film. When the average fiber diameter of the conductive fibers 32 is 300 nm or less, the diameter does not become too large, so that the pore volume in the porous member 30 can be easily secured sufficiently. Accordingly, the gas diffusibility of the gas diffusion layer 3 can be further enhanced.

The average fiber length of the conductive fibers 32 is preferably 0.5 μm or more and 50 μm or less. When the average fiber length of the conductive fibers 32 is 0.5 μm or more, it is possible to more effectively contribute to improvement of conductivity of the gas diffusion layer 3 and to further enhance mechanical strength of the gas diffusion layer 3. When the average fiber length of the conductive fibers 32 is 50 μm or less, the fibers are not excessively long, so that the conductive fibers 32 are crushed without forming lumps during manufacturing, and the gas diffusibility of the gas diffusion layer 3 can be further enhanced.

Examples of the polymer resin 33 include PTFE (polytetrafluoroethylene), FEP (tetrafluoroethylene-hexafluoropropylene copolymer), PVDF (polyvinylidene fluoride), ETFE (tetrafluoroethylene-ethylene copolymer), PCTFE (polychlorotrifluoroethylene), and PFA (polyfluoroethylene-perfluoroalkyl vinyl ether copolymer). Among them, PTFE is preferably used as the polymer resin 33 from the viewpoint of heat resistance, water repellency, and chemical resistance. Examples of the raw material form of PTFE include dispersion, powder, and the like. Among them, dispersions are preferable because of excellent dispersibility.

The polymer resin 33 has a function as a binder that binds the conductive particles 31 and the conductive fibers 32 to each other. The polymer resin 33 has water repellency, and therefore also has a role of preventing water from staying in pores inside the gas diffusion layer 3 and gas permeation from being inhibited.

Further, in the gas diffusion layer 3, the conductive particles 31 exist in gaps between the conductive fibers 32, and the conductive fibers 32 and the conductive particles 31 can be favorably bound by the fibrous polymer resin 33, so that the gas diffusion layer 3 can have sufficient strength.

### <Composition of Composite Powder Used in Gas Diffusion Layer >

The composite powder used for the gas diffusion layer preferably contains 5 wt % or more and less than 35 wt % of the conductive particles 31. That is, the content ratio of the conductive particles 31 is preferably 5 wt % or more and less than 35 wt % with respect to the entire gas diffusion layer 3. In the gas diffusion layer prepared from the composite powder, when the content ratio of the conductive particles 31 is 5 wt % or more, the amount of the conductive particles 31 filling gaps between the conductive fibers 32 becomes a sufficient amount, so that bulk resistance of the gas diffusion layer 3 is less likely to increase. When the content ratio of the conductive particles 31 is less than 35 wt %, the gaps between the conductive fibers 32 are not excessively reduced, so that water dischargeability and gas diffusibility are further improved.

The composite powder used for the gas diffusion layer preferably contains 35 wt % or more and 80 wt % or less of the conductive fibers 32. That is, the content ratio of the conductive fibers 32 is preferably 35 wt % or more and 80 wt % or less with respect to the entire gas diffusion layer 3. In the gas diffusion layer prepared from the composite powder, when the content ratio of the conductive fibers 32 is 35 wt % or more, the gaps between the conductive fibers 32 are not excessively reduced, so that water dischargeability and gas diffusibility are improved. When the content ratio of the conductive fibers 32 is 80 wt % or less, the amount of particles filling gaps between the conductive fibers 32 becomes a sufficient amount, so that bulk resistance of the gas diffusion layer 3 is less likely to increase.

The composite powder used for the gas diffusion layer preferably contains 1 wt % or more and 40 wt % or less of the polymer resins 33. That is, the content ratio of the polymer resin 33 is preferably 1 wt % or more and 40 wt % or less with respect to the entire composite powder. In the gas diffusion layer prepared from the composite powder, when the content ratio of the polymer resin 33 is 1 wt % or more, the polymer resin 33 sufficiently functions as a binder, and the tensile rupture strength of the gas diffusion layer can be increased. Therefore, even when the pressure of the gas or the swelling and shrinkage of the electrolyte membrane occurs, the gas diffusion layer is less likely to break, and the durability of the fuel cell is improved. In addition, when the content ratio of the polymer resin 33 is 40 wt % or more, the bulk resistance of the gas diffusion layer is less likely to increase, and the battery performance can be improved.

### <Gas Diffusion Layer >

The gas diffusion layer 3 contains conductive particles 31, conductive fibers 32, and a polymer resin 33. The gas diffusion layer 3 is preferably a free-standing film supported by the conductive particles 31, the conductive fibers 32, and the polymer resin 33. The free-standing film means a film having a self-supporting structure.

In a Log differential pore volume distribution graph measured by a mercury intrusion method, pores having a peak in a pore radius range of 0.055 μm or more and 0.4 μm or less are present inside the gas diffusion layer 3.

Here, the pores inside the gas diffusion layer 3 will be described.

The pores inside the gas diffusion layer 3 have the following three functions. First, there is a function of diffusing the fuel gas and the oxidant gas flowing through the gas flow path of the separator into the catalyst 2. Second, there is a function of controlling generated water generated by the reaction to retain the catalyst layer 2 and the polymer electrolyte membrane 1, and quickly discharging excess generated water to the outside through pores. Third, there is a function of sending moisture in the humidified fuel gas and oxidant gas to the catalyst layer 2 and the polymer electrolyte membrane 1 under the condition that the catalyst 2 and the polymer electrolyte membrane 1 cannot be sufficiently retained only with generated water, and securing proton conductivity.

When the gas diffusion layer 3 has pores with a pore radius of 0.055 μm or more and 0.4 μm or less inside, the permeability of water vapor can be sufficiently secured in the pores of this size, and the permeability to condensed water or micro mist is suppressed. Therefore, it is possible to quickly discharge excess moisture as water vapor while maintaining the catalyst layer 2 and the polymer electrolyte membrane 1 in an appropriate water-containing state.

Pores having a pore radius of 0.055 μm or more and 0.4 μm or less are formed by gaps between the conductive fibers 32. Therefore, when the amount of the conductive fibers 32 constituting the gas diffusion layer 3 is larger than that of the conductive particles 31, the peak of the pore radius in the gas diffusion layer 3 can be formed in the range of 0.055 μm or more and 0.4 μm or less.

The pore volume of pores with a pore radius of 0.055 μm or more and 0.4 μm or less is preferably 0.60 mL/g or more. When the pore volume is less than 0.60 mL/g, gas diffusibility is deteriorated, and battery performance particularly in a high current density region is deteriorated.

The pore volume of pores with a pore radius of 0.055 μm or more and 0.4 μm or less is more preferably 0.80 mL/g or more. When the pore volume is 0.80 mL/g or more, a discharge path of surplus generated water in the MEA and a gas diffusion path from the separator can be sufficiently secured during operation under high humidification or in a high current density region, and battery performance can be further improved.

Further, the gas diffusion layer 3 may have pores having two peaks in a Log differential pore volume graph measured by a mercury intrusion method, the pores with a pore radius of 0.055 μm or more and 0.4 μm or less having a pore volume of 0.60 mL/g or more, and the pores having a pore radius of 0.4 μm or more and 10 μm or less having a pore volume of 0.1 mL/g or more. The pores having a pore radius of 0.055 μm or more and 0.4 μm or less are formed by gaps between the conductive fibers in the composite powder as described above.

On the other hand, pores having a pore radius of 0.4 μm or more and 10 μm or less are pores generated by an interface or the like between the composite powders, and have a function of discharging condensed water generated in a gap or the like between an interface between the catalyst layer 2 and the gas diffusion layer 3 or condensed water generated by condensation of water vapor in submicron pores of the composite powder 34 inside the gas diffusion layer 3 to the outside by a capillary phenomenon.

The pore volume of the pores having a peak in the range of a pore radius of 0.4 μm or more and 10 μm or less is 0.1 mL/g or more. When the pore volume is less than 0.1 mL/g, the discharge performance of condensed water generated in the gas diffusion layer is deteriorated, and the gas diffusibility may be deteriorated.

The pore size distribution and the pore volume of the gas diffusion layer 3 can be measured by a mercury intrusion method after drying the gas diffusion layer 3 at 120° C. (CelsiusDegree) for 4 hours as pretreatment.

### <Porosity >

A porosity, which is a volume ratio of voids having a size of 10 μm or more in the gas diffusion layer 3, is 0.5% (volume %) or less.

In voids having a size of 10 μm or more inside the gas diffusion layer, water vapor is condensed and retained as liquid water, which causes inhibition of gas diffusibility. Therefore, when the porosity of voids having a size of 10 μm or more in the gas diffusion layer 3 is 0.5% or less, liquid water is less likely to remain in the gas diffusion layer, and particularly gas diffusibility during power generation in a high current density region is improved.

Here, the reason why the porosity of voids having a size of 10 μm or more in the gas diffusion layer 3 is 0.5% or less will be described.

In a conventional gas diffusion layer in which an MPL layer is formed on a base material of carbon paper or carbon felt, a void having a size of several μm to several tens of μm exists as a gap between carbon fibers in a base material portion, and liquid water tends to be retained in the base material portion. On the other hand, the MPL layer is formed by applying a kneaded product of carbon black and PTFE to the surface of the base material with a die or a spray, and has a pore diameter of several tens of nm which is a gap between primary aggregates (aggregates) of carbon black. However, when the MPL layer is formed by a die or a spray, many voids having a size of 10 μm or more are formed inside the MPL due to irregularities and coating defects of the base material and shrinkage of the solvent during drying.

On the other hand, the gas diffusion layer 3 according to the present disclosure is obtained by rolling a powder in which the average porosity of the composite powder is 50 vol % or more and 98 vol % or less and the deformation strength of the composite powder is 1 kPa or more and 60 kPa or less with a roll. Although the porosity of the powder is high, since the powder is a composite powder which is easily deformed, the powders adhere to each other by roll pressing, so that it is possible to significantly reduce voids having a size of 10 μm or more.

The porosity of voids having a size of 10 μm or more in the gas diffusion layer was measured by the following method.
Method: Observation by X-ray CT
Apparatus: Xradia 620 Versa (manufactured by Carl Zeiss)
Tube voltage: 80 kV
Observation field: about 1.0 mm² (resolution: 1 μm/pixel)

Porosity calculation: The X-ray CT image was binarized by imageJ, the volume of voids with a size of 10 μm or more and the volume other than voids were calculated, and the porosity (% by volume) inside the GDL was calculated from (void volume with a size of 10 μm or more)/(void volume with a size of 10 μm or more +volume other than voids). Further, from (the area of voids with a size of 10 μm or more exposed on the surface of the gas diffusion layer)/(the surface area of the gas diffusion layer), the porosity (area %), which is the area ratio of voids with a size of 10 μm or more on the surface of the gas diffusion layer, was calculated.

### <Membrane Electrode Assembly: MEA>

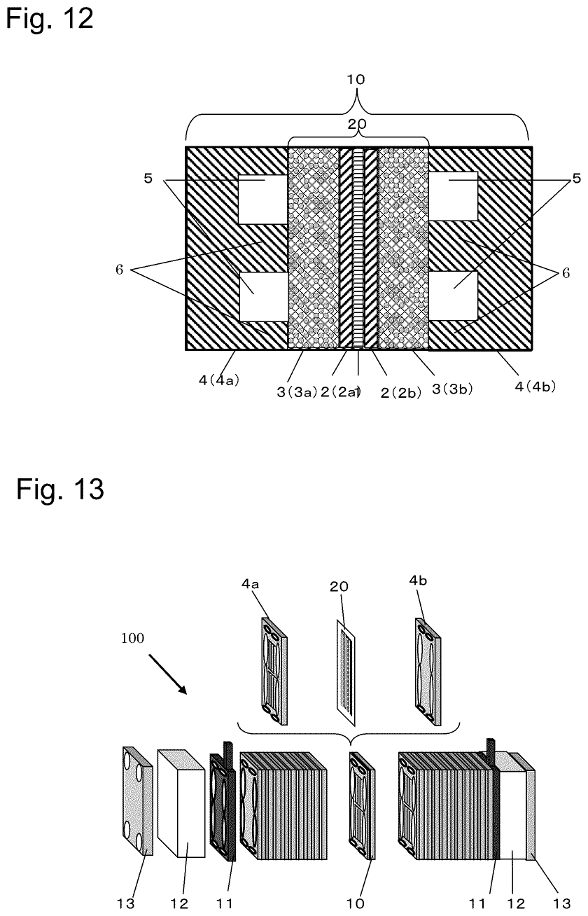

FIG. 12 is a schematic cross-sectional view showing a cross-sectional structure of the polymer electrolyte fuel cell according to the first embodiment.

A membrane electrode assembly (MEA) 20 includes a polymer electrolyte membrane 1, a catalyst layer 2, and a gas diffusion layer 3. An anode catalyst layer 2a and a cathode catalyst layer 2b (combined catalyst layer 2) are formed on both surfaces of the polymer electrolyte membrane 1 that selectively transports hydrogen ions, and an anode-side gas diffusion layer 3a and a cathode gas diffusion layer 3b (combined gas diffusion layer 3) are disposed outside the anode catalyst layer 2a and the cathode catalyst layer 2b, respectively.

For the polymer electrolyte membrane 1, for example, a perfluorocarbon sulfonic acid polymer is used, but it is not particularly limited as long as it has proton conductivity.

As the catalyst layer 2, a layer containing a carbon material carrying catalyst particles such as platinum and a polymer electrolyte can be used.

### <Fuel Cell>

FIG. 13 is a schematic perspective view showing a configuration of a polymer electrolyte fuel cell stack according to the first embodiment.

As shown in FIG. 13, in a fuel cell 100, one or more battery cells 10 as a basic unit are stacked, and compressed and fastened with a predetermined load using current collecting plates 11, insulating plates 12, and end plates 13 disposed on both sides of the stacked battery cells 10.

The current collecting plate 11 is formed of a gas-impermeable conductive material. For example, copper, brass, or the like is used for the current collecting plate 11. The current collecting plate 11 is provided with a current extraction terminal portion (not shown), and a current is extracted from the current extraction terminal portion at the time of power generation.

The insulating plate 12 is formed of an insulating material such as resin. For example, a fluorine-based resin, a PPS resin, or the like is used for the insulating plate 12.

The end plates 13 fasten and hold one or more stacked battery cells 10, the current collecting plates 11, and the insulating plates 12 with a predetermined load by a pressurizing means (not shown). A highly rigid metal material such as steel is used for the end plate 13.

FIG. 12 is a schematic cross-sectional view showing a cross-sectional structure of the battery cell 10. In the battery cell 10, the membrane electrode assembly (hereinafter, also referred to as MEA) 20 is sandwiched between an anode side separator 4a and a cathode side separator 4b. Hereinafter, the anode side separator 4a and the cathode side separator 4b are collectively referred to as a separator 4. In a case where a plurality of other components are described together, the same description will be made.

A fluid flow path 5 is formed in the separator 4. A fluid flow path 5 for fuel gas is formed in the anode side separator 4a. A fluid flow path 5 for oxidant gas is formed in the cathode side separator 4b. A carbon-based material and a metal-based material can be used for the separator 4.

The fluid flow path 5 is a groove formed in separator 4. A rib portion 6 is provided around the fluid flow path 5.

### Examples

Hereinafter, examples of the present disclosure will be described.

### (Materials)

The materials used for manufacturing the test pieces of examples and comparative examples are as follows.

### [Conductive Particles 31]

Li-400 (manufactured by Denka Company Limited)

### [Conductive Fibers 32]

VGCF (VGCF-H manufactured by Showa Denko K.K.)

### [Polymer Resin 33]

PTFE dispersion (manufactured by DAIKIN CORPORATION), average particle diameter: 0.25 μm

### [Method for Manufacturing Composite Powder]

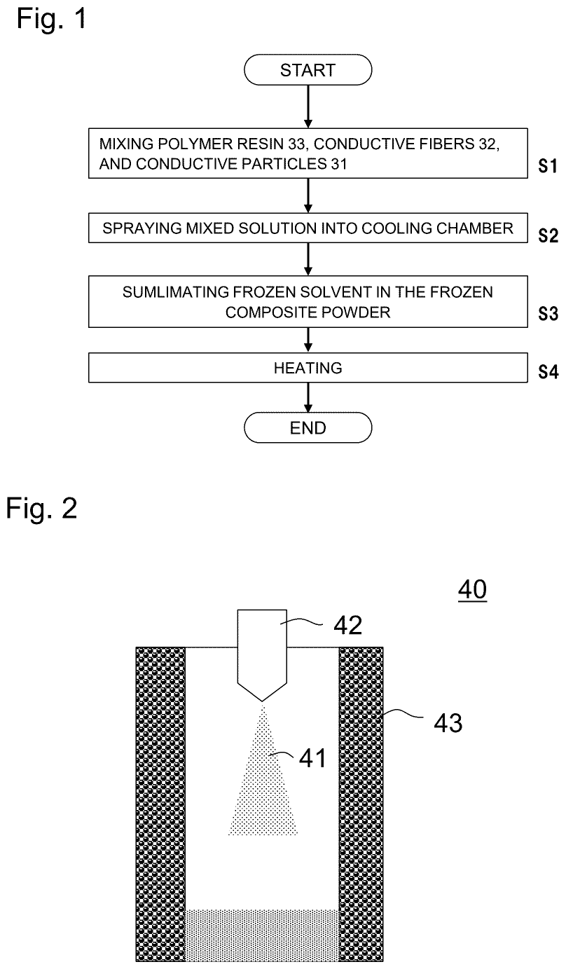

First, a method for manufacturing a composite powder according to the first embodiment will be described with reference to FIGS. 1 to 5.

FIG. 1 is a diagram showing an example of a flowchart of a method for manufacturing a composite powder by a freeze granulation method according to Example 1.

FIG. 2 is a schematic configuration diagram of a spray freezing granulation device 40.

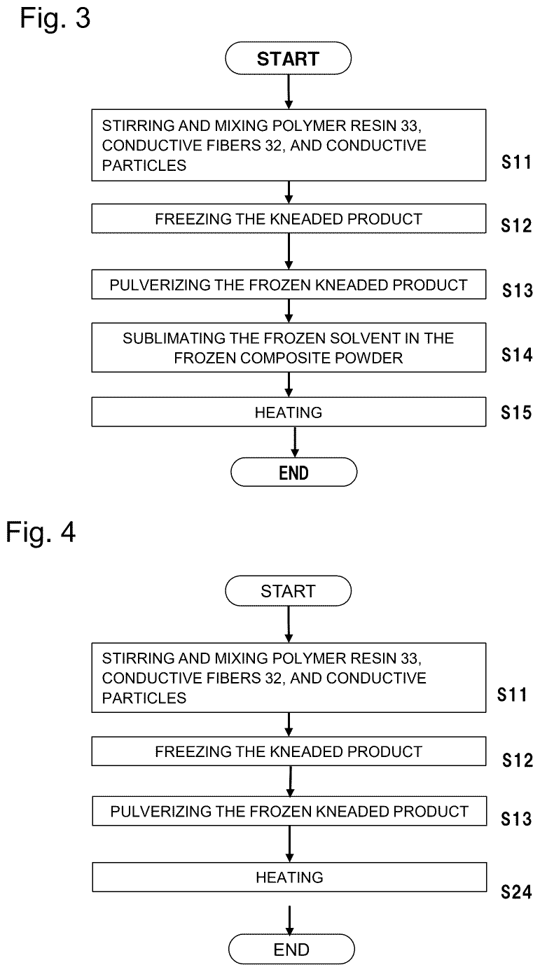

FIG. 3 is a diagram showing an example of a flowchart of a method for manufacturing a composite powder by a freeze pulverization method according to Example 2.

FIG. 4 is a diagram showing an example of a flowchart of a method for manufacturing a composite powder by a freeze pulverization method according to Example 3.

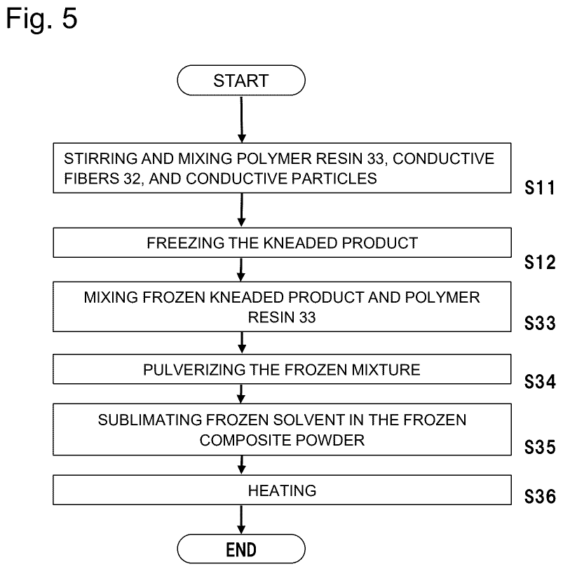

FIG. 5 is a diagram showing an example of a flowchart of a method for manufacturing a composite powder by a freeze pulverization method according to Example 4.

### Method for Manufacturing Composite Powder of Example 1-1

Hereinafter, a method for manufacturing a composite powder according to Example 1-1 will be described with an example. As shown in FIG. 1, the method for manufacturing a composite powder according to the present embodiment includes a step (S1) of mixing the polymer resin 33, the conductive fibers 32, and the conductive particles 31 with a dispersion solvent (here, water and a surfactant) to obtain a mixed solution, a step (S2) of spraying the mixed solution into a cooling chamber to form a frozen composite powder to obtain a frozen composite powder, and a step (S3) of sublimating the frozen solvent in the frozen composite powder to form a dried composite powder (that is composite powder). Although the flowchart of FIG. 1 shows the case of the method for manufacturing a composite powder according to Example 1-2 described later including a heating step (S4), the heating step (S4) is not essential.

Hereinafter, a method for manufacturing a composite powder according to Example 1-1 will be described more specifically.

In step S1, carbon particles 31, carbon fibers 32, and a PTFE 33 were blended at a ratio of 15:65:20 wt %, and a solution having a solid content concentration of 20 wt % with water and a surfactant was mixed with a planetary mixer so that a mixed solution was obtained. The solid content concentration in the mixed solution may have a sprayable viscosity of 5000 mPa's and 25° C. or lower, and is preferably 1 wt % or more and 50 wt % or less. For mixing the solution in step S1, for example, a hybrid mixer, a kneader, a roll mill, or the like can be used in addition to the planetary mixer. In addition, the mixed state and fiberization of PTFE can be controlled by appropriately selecting the solid content concentration, the mixing method, and the like.

In step S2, the mixed solution 41 was sprayed as a plurality of droplets via nozzle 42 at a supply rate of 5 kg/h into a cooling chamber 43 at −50° C. of the spray freezing granulation device 40 shown in FIG. 2 to prepare a frozen composite powder including a plurality of frozen droplets. The spraying mechanism can use, for example, a two-fluid nozzle, a one-fluid pressurizing nozzle, a three-fluid nozzle, a four-fluid nozzle, an ultrasonic nozzle, a centrifugal sprayer, or the like. As the refrigerant used for the cooling chamber, liquid nitrogen, nitrogen gas, liquid argon, argon gas, liquid helium, helium gas, dry ice, carbon dioxide gas, cooling gas obtained by cooling the atmosphere, or the like can be used. The cooling temperature may be equal to or lower than a temperature at which the solution to be used freezes, but is preferably −10 to −150° C. in consideration of cooling efficiency. The particle diameter of the frozen composite powder depends on the raw material, the solid content concentration of the mixed solution, the spraying mechanism, the cooling temperature, and the like, but can be controlled to 1 to 1000 μm at the average particle diameter D50.

In step S3, moisture which is a frozen dispersion solvent contained in the frozen composite powder is removed by sublimation at a non-melting temperature under reduced pressure. It is sufficient that the frozen moisture is not melted, and the moisture may be sublimated under reduced pressure or normal pressure. Sublimation of moisture makes it possible to maintain a space in which moisture existed, and thus a large-void powder can be prepared. When the moisture content is 5 wt % or less, the powder are less likely to aggregate and can be handled as a powder.

### Method for Manufacturing Composite Powder of Example 1-2

Hereinafter, a method for manufacturing a composite powder according to Example 1-2 will be described with an example. As shown in FIG. 1, the method for manufacturing a composite powder according to the present embodiment includes a step (S1) of mixing the polymer resin 33, the conductive fibers 32, and the conductive particles 31 with a dispersion solvent (here, water and a surfactant) to obtain a mixed solution, a step (S2) of spraying a mixed solution into a cooling chamber to form a frozen composite powder including a plurality of frozen droplets, a step (S3) of sublimating the frozen solvent in the frozen composite powder to form a dried composite powder, and a step (S4) of further performing heat treatment (heating).

Hereinafter, the method for manufacturing a composite powder according to Example 1-2 will be described more specifically.

Step 1-3 was performed in the same manner as Example 1-1.

In step S4, the composite powder from which the moisture had been removed was further heated at 300° C. for 3 hours. By heating, PTFE is softened and easily formed into fibers. At the same time, by thermal expansion of carbon particles 31 and carbon fibers 32, it is possible to promote the fiberization of PTFE, and by holding the thermally expanded carbon particles 31 and carbon fibers 32, it is possible to further increase voids. Fiberization of PTFE can be controlled by controlling the time at 100° C. or higher at which fiberization of PTFE easily proceeds and 400° C. or lower at which PTFE is decomposed.

### Method for Manufacturing Composite Powder of Example 2

Hereinafter, a method for manufacturing a composite powder according to Example 2 will be described with an example. As shown in FIG. 3, the method for manufacturing a composite powder according to the present embodiment includes: a step (S11) of stirring and mixing a polymer resin 33, conductive fibers 32, and conductive particles 31 with a dispersion solvent (here, water and a surfactant) to obtain a kneaded product; a step (S12) of freezing the kneaded product to obtain a frozen kneaded product; a freeze-pulverization step (S13) of pulverizing the frozen kneaded product to manufacture frozen composite powder; a step (S14) of sublimating the frozen solvent in the frozen composite powder to form a dried composite material; and a step (S15) of performing heat treatment (heating) to obtain a composite powder.

Hereinafter, a method for manufacturing a composite powder will be described more specifically.

In step S11, a kneaded product obtained by blending carbon particles 31, carbon fibers 32, and a PTFE 33 at a ratio of 15:65:20 wt % and further mixing water and a surfactant to a solid content concentration of 30 wt % was mixed with a planetary mixer so that a mixed solution was obtained. The solid content concentration in the mixed solution is preferably 20 to 80 wt %. 20 to 50 wt % is still more preferable. By reducing the solid content concentration, the voids are filled with the solvent, and powder with larger voids can be obtained. For mixing the solution in step S1, for example, a hybrid mixer, a kneader, a roll mill, or the like can be used in addition to the planetary mixer. In addition, the mixed state and fiberization of PTFE can be controlled by appropriately selecting the solid content concentration, the mixing method, and the like.

In step S12, the kneaded product was immersed in liquid nitrogen and frozen to prepare a frozen kneaded product. As the refrigerant used for the freezing, liquid nitrogen, nitrogen gas, liquid argon, argon gas, liquid helium, helium gas, dry ice, carbon dioxide gas, or cooling gas obtained by cooling the atmosphere, a freezer, or the like can be used. Depending on the solvent type, the cooling temperature may be equal to or lower than the temperature at which the solution to be used is frozen, but is preferably −10 to −150° C. in consideration of cooling efficiency. The freezing rate may be gradually cooled or rapidly frozen. By gradual cooling, ice crystals become large, and larger voids can be prepared.

In step S13, the frozen kneaded product was pulverized by a cooled pulverizer to manufacture frozen composite powder. As the pulverization method, an impact type using a pin or a hammer, a cutter knife type, a rotary blade type, or the like can be used. As the refrigerant used for the pulverization, liquid nitrogen, nitrogen gas, liquid argon, argon gas, liquid helium, helium gas, dry ice, carbon dioxide gas, cooling gas obtained by cooling the atmosphere, or the like can be used. The average particle diameter of the frozen composite powder depends on the raw material, the frozen state, the pulverization method, the pulverization conditions, and the like, but can be controlled to 1 to 1000 μm at an average particle diameter D50.

In step S14, the frozen moisture contained in the frozen composite powder is removed by sublimation at a non-melting temperature under reduced pressure. The moisture may be prevented from being melted, and the moisture may be sublimated under reduced pressure or normal pressure. Sublimation of moisture makes it possible to maintain a space in which moisture existed, and thus a large-void powder can be prepared. When the moisture content is 5 wt % or less, the powder are less likely to aggregate and can be handled as a powder.

In step S15, the powder from which the moisture had been removed was further heated at 300° C. for 3 hours. By heating, PTFE is softened and easily formed into fibers, and at the same time, fiber formation of PTFE can be promoted by thermal expansion of the carbon particles 31 and the carbon fibers 32. At the same time, by holding the thermally expanded carbon particles 31 and carbon fibers 32, the voids can be further increased. Fiberization of PTFE can be controlled by controlling the time at 100° C. or higher at which fiberization of PTFE easily proceeds and 400° C. or lower at which PTFE is decomposed.

### Method for Manufacturing Composite Powder of Example 3

Hereinafter, a method for manufacturing a composite powder according to Example 3 will be described with an example. As shown in FIG. 4, the method for manufacturing a composite powder according to Example 3 includes a step (S11) of stirring and mixing a polymer resin 33, conductive fibers 32, and conductive particles 31 with a dispersion solvent (here, water and a surfactant) to obtain a kneaded product, a step (S12) of freezing the kneaded product to obtain a frozen kneaded product, a freeze-pulverization step (S13) of pulverizing the frozen kneaded product to obtain a frozen composite powder, and a step (S24) of heating the frozen composite powder under atmospheric pressure to obtain a dried composite powder.

Steps S11 to 13 were performed in the same manner as in Example 2.

In step S24, the frozen composite powder was heated at 300° C. for 3 hours under atmospheric pressure to remove the solvent, thereby obtaining a dried composite powder. The heating temperature and time may be set to 100 to 400° C. and 0.1 to 6 hours at which the solvent can be removed and PTFE is not melted. By removing moisture through a liquid state, surface tension acts on the particle surface in the composite powder, the particle shape in the composite powder can be smoothed, and the fluidity can be improved.

### Method for Manufacturing Composite Powder of Example 4

Hereinafter, a method for manufacturing a composite powder according to Example 4 will be described with an example. As shown in FIG. 5, the method includes a step (S33) of mixing a frozen kneaded product obtained by freezing a kneaded product prepared in the same manner as in the second and third embodiments and a polymer resin to obtain a frozen mixture, a freeze-pulverization step (S34) of pulverizing the frozen mixture to obtain a frozen composite powder, a step (S35) of sublimating a frozen solvent in the frozen composite powder to form a dried composite powder, and a step (S36) of further heating to obtain a dried composite powder.

Steps S11 and S12 were performed in the same manner as in Examples 2 and 3.

In step S33, the frozen kneaded product and the polymer resin 33 were mixed while being cooled at a blending ratio of solid content of the frozen kneaded product: polymer resin=90: 10 wt % to prepare a frozen mixture. As the polymer resin, a dry powder, a frozen dispersion, or the like can be used. The blending ratio is preferably the solid content of the kneaded product: polymer resin=99:1 to 70: 30 wt %. When the blending ratio of the polymer resin is too large, the resistance of the film increases when the polymer resin is formed into a film, and on the other hand, when the blending ratio is too small, the strength of the film decreases.

In step S34, the frozen mixture was pulverized by a cooled pulverizer to obtain a frozen composite powder. As the pulverization method, an impact type using a pin or a hammer, a cutter knife type, a rotary blade type, a cutter mill type, or the like can be used. As the refrigerant used for the pulverization, liquid nitrogen, nitrogen gas, liquid argon, argon gas, liquid helium, helium gas, dry ice, carbon dioxide gas, cooling gas obtained by cooling the atmosphere, or the like can be used. By simultaneously subjecting the frozen mixture of the polymer resin and the frozen kneaded product to freezing and pulverization, it is possible to obtain a frozen mixture of the pulverized frozen kneaded product and the pulverized polymer resin while suppressing fiberization. In addition, by applying a shear force simultaneously with pulverization, the pulverized polymer resin can be attached to the surface of the pulverized frozen kneaded product. Although the average particle diameter of the frozen composite powder depends on the raw material, the frozen state, the pulverization method, the pulverization conditions, and the like, the average particle diameter D50 can be controlled to 1 to 1000 μm.

In step S35, the frozen moisture contained in the frozen composite powder is removed by sublimation at a temperature at which the frozen moisture is not melted under reduced pressure. The frozen moisture may be prevented from being melted, and the frozen moisture may be sublimated under reduced pressure or normal pressure. Sublimation of moisture makes it possible to maintain a space in which moisture existed, and thus a large-void powder can be prepared. When the moisture content is 5 wt % or less, the particles are less likely to aggregate and can be handled as a powder.

In step S36, the frozen composite powder from which the moisture had been removed was further heated at 300° C. for 3 hours. By heating, PTFE is softened and easily formed into fibers, and at the same time, fiber formation of PTFE can be promoted by thermal expansion of the carbon particles 31 and the carbon fibers 32. At the same time, by holding the thermally expanded carbon particles 31 and carbon fibers 32, the voids can be further increased. Fiberization of PTFE can be controlled by controlling the time at 100° C. or higher at which fiberization of PTFE easily proceeds and 400° C. or lower at which PTFE is decomposed.

Further, the drying may be performed in S36 without performing S35.

### Method for Manufacturing Composite Powder of Reference Example 1

First, a surfactant and a dispersion solvent were added to carbon particles 31, carbon fibers 32, and a PTFE 33 mixed at a blending ratio of 15:65:20 wt %, and kneaded using a planetary mixer to obtain a kneaded mixture. Next, the kneaded mixture was fired at 300° C. for 4 hours in a hot air firing furnace to remove the surfactant and the dispersion solvent so that a fired mixture was obtained. Thereafter, the fired mixture was pulverized using a cutter mill to prepare a composite powder.

### Method for Manufacturing Gas Diffusion Layer

The composite powder was put into a roll press and formed into a sheet with a pressing force of 0.5 ton/cm to prepare a gas diffusion layer. The thickness of each of the gas diffusion layers was 160 μm.

The raw material compositions of Examples and Reference Examples and the evaluation results of the obtained composite powder and gas diffusion layer are shown in Table 1 below.

TABLE 1

| | | | | | | | Reference |
|---|---|---|---|---|---|---|---|
| | | Example | | | | | Example |
| | | 1-1 | 1-2 | 2 | 3 | 4 | 1 |
| Raw Material | Added Amount of Conductive Particles 31 (wt %) | 15 | 15 | 15 | 15 | 15 | 15 |
| Composition | Added Amount (wt %) of Conductive Fibers 32 | 65 | 65 | 65 | 65 | 65 | 65 |
| | Added Amount (wt %) of Polymer Resin 33 | 20 | 20 | 20 | 20 | 10 | 20 |
| Proportion (wt %) of Polymer Resin 33 to be Added Later | | — | — | — | — | 10 | — |
| composite | Average Particle Diameter D50 (μm) | 75 | 80 | 60 | 82 | 70 | 65 |
| powder | Average Porosity (% by Volume) | 90 | 95 | 90 | 80 | 88 | 85 |
| | Degree of Sphericity (Sphericity) | 0.04 | 0.03 | 0.5 | 0.4 | 0.5 | 0.56 |
| | Degree of fiberization (%) | 0 | 55 | 60 | 65 | 62 | 75 |
| | Pore Volume (0.055 to 0.4 μm) | 0.81 | 1.1 | 0.84 | 0.82 | 0.83 | 0.72 |
| | Degree of Aggregation (%) | 30 | 15 | 25 | 20 | 30 | 35 |
| | Deformation Strength (kPa) | 8 | 20 | 40 | 50 | 40 | 61 |
| Gas Diffusion | Pore Volume (0.055 to 0.4 μm) (mL/g) | 0.80 | 0.92 | 0.82 | 0.80 | 0.81 | 0.58 |
| Layer 3 | Pore Volume (0.4 to 10 μm) (mL/g) | 0.14 | 0.11 | 0.18 | 0.19 | 0.18 | 0.32 |
| | Porosity of 10 μm or More_Volume Ratio (%) | 0.02 | 0.09 | 0.11 | 0.34 | 0.12 | 0.67 |
| | Porosity of 10 μm or More_Surface Area Ratio | 0.01 | 0.03 | 0.05 | 0.24 | 0.07 | 0.64 |
| | (%) | | | | | | |

### (Manufacture of Single Cell Evaluation Cell)

Catalyst-carrying carbon having platinum particles carried on carbon powder as an electrode catalyst (TEC10E50E manufactured by Tanaka Kikinzoku Kogyo K. K., 50 mass % of Pt) and a polymer electrolyte solution having hydrogen ion conductivity (Nafion dispersion) were dispersed in a mixed dispersion medium of ethanol and water (mass ratio 1:1) to prepare an ink for forming a cathode catalyst layer. The polymer electrolyte was added so that the mass of the polymer electrolyte in the catalyst layer after coating formation was 0.4 times the mass of the catalyst-carrying carbon.

The obtained ink for forming a cathode catalyst layer was applied to one surface of a polymer electrolyte membrane (GSII manufactured by Japan Gore-Tex Corporation, 120 mm×120 mm) by a spray method to form a cathode catalyst layer so that the platinum carrying amount was 0.3 mg/cm².

Next, similarly to the cathode electrode, an anode catalyst layer was formed so that the platinum carrying amount was 0.1 mg/cm².

As the anode-side gas diffusion layer, carbon paper manufactured by SGL was used.

The gas diffusion layers of Example 1 and Reference Example 1 were joined to a cathode catalyst layer as a cathode-side gas diffusion layer. The anode-side gas diffusion layer was bonded to the anode catalyst layer. Thus, the MEA was obtained.

Next, a fuel cell, which was a test piece, was manufactured using the separator in which the flow path was formed. First, the manufactured MEA was sandwiched between an anode side separator having a fluid flow path for supplying a fuel gas and a cooling water flow path and a cathode side separator having a gas flow path for supplying an oxidant gas, and a fluororubber gasket was disposed around the cathode and the anode to manufacture a unit cell. The effective electrode (anode or cathode) area is 36 cm². This unit cell was used as a test piece. (Evaluation Test)

The following evaluation tests were performed for Example 1-2 and Reference Example 1.

### [Cell Voltage]

The cell voltage was measured under the following conditions. The cell temperature of the unit cell of the test piece was controlled to 75° C., hydrogen gas was supplied as fuel gas to the gas flow path on the anode side, and air was supplied to the gas flow path on the cathode side. The stoichiometry of hydrogen gas was 1.5, and the stoichiometry of air was 1.8. The fuel gas and the air were humidified so that the dew point was 75° C. at the time of high-humidification power generation and the dew point was 45° C. at the time of low-humidification power generation, and then supplied to the unit cell. A cell voltage at a current density of 2.0 A/cm² was measured while the cell was held at every 0.5 A/cm² for 3 minutes from a current density of 0 A/cm² to 2.0 A/cm².

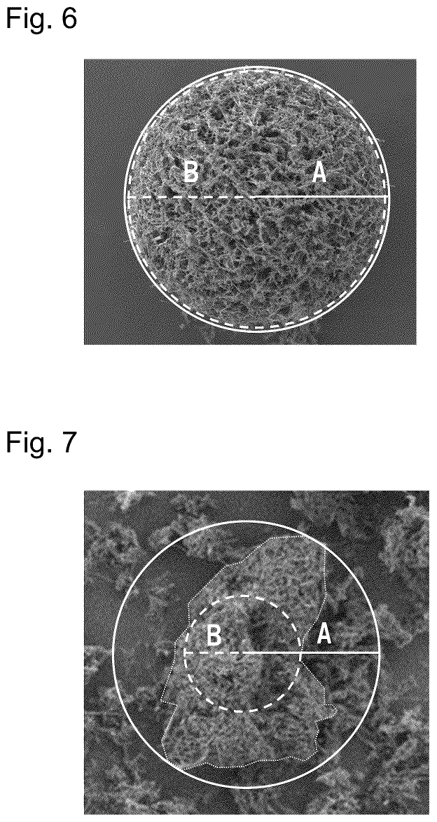

FIG. 6 is a SEM image of the composite powder according to Example 1, in which the maximum radius A of the maximum geometric circle that is a circumscribed circle is 3.2 μm, the minimum radius B of the minimum geometric circle that is an inscribed circle is 3.1 μm, and the difference (A−B) is 0.1 μm, and thus the sphericity (A−B)/A is 0.03, which satisfies the above Expression (1).

FIG. 7 is a SEM image of the composite powder according to Reference Example 1, in which the maximum radius A of the maximum geometric circle that is a circumscribed circle is 3.22 μm, the minimum radius B of the minimum geometric circle that is an inscribed circle is 1.4 μm, and the difference (A−B) is 1.82 μm, and thus the sphericity (A−B)/A is 0.56, which does not satisfy the above Expression (1).

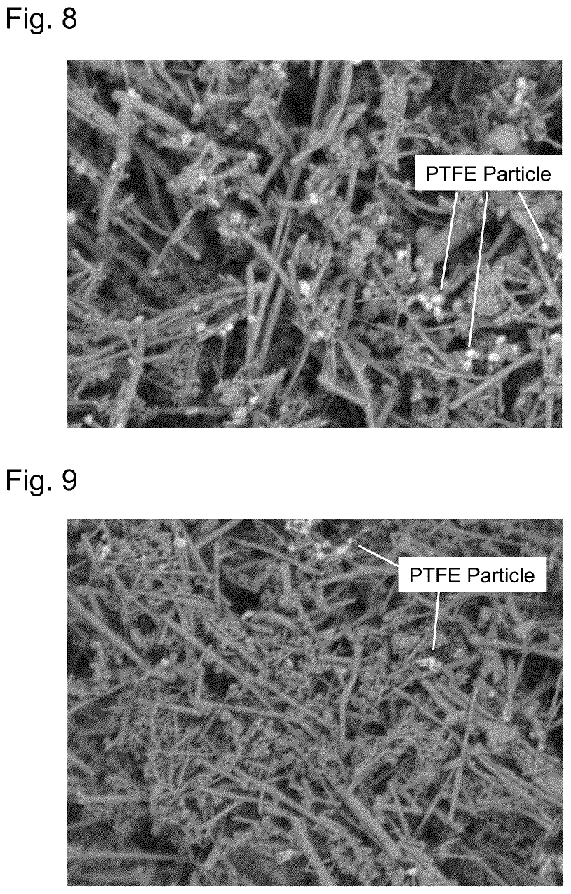

FIG. 8 is an SEM image showing PTFE particles that are not formed into fibers in the composite powder according to Example 1. FIG. 9 is an SEM image showing PTFE particles that are not formed into fibers in the composite powder according to Reference Example 1.

As shown in FIG. 8, it can be seen that in the composite powder according to Example 1, there are relatively many PTFE particles that are not formed into fibers, and the degree of fiberization is 70% or less. On the other hand, as shown in FIG. 9, it can be seen that in the composite powder according to Reference Example 1, the number of PTFE particles not formed into fibers is relatively small, and the degree of fiberization exceeds 70%.

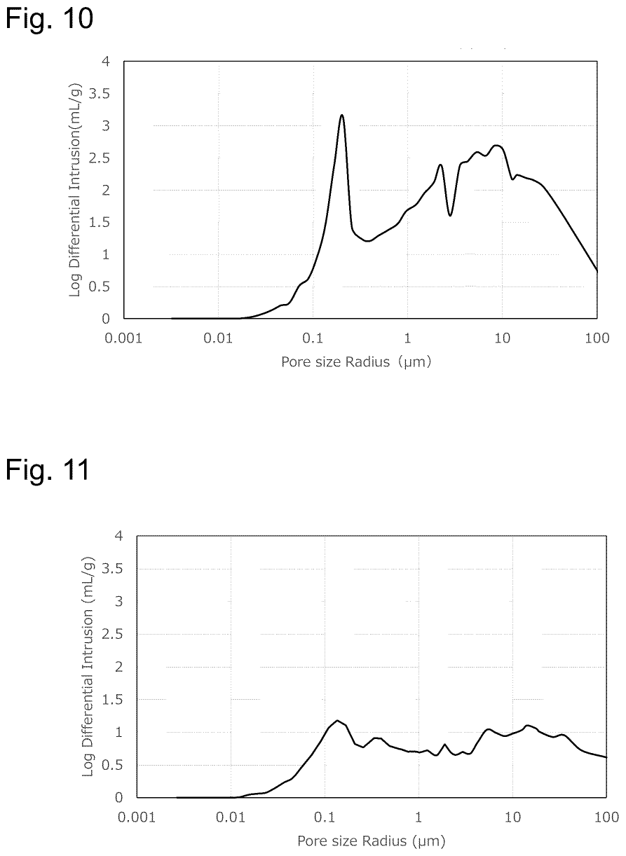

FIG. 10 is a diagram showing a pore distribution of a composite powder according to Example 1-2.

The composite powder of Example 1-2 has an average particle diameter D50 of 80 μm, and as shown in FIG. 10, the average porosity calculated from the pore volume with a pore radius of 0.001 to 100 μm in the pores inside the powder is 95%, and the pore volume with a pore radius of 0.055 to 0.4 μm in the pores inside the powder is 1.1 mL/g. By rolling the composite powder of Example 1 by roll pressing, the peak of the pore radius is 0.1 to 0.3 μm and the pore volume at the pore radius of 0.055 to 0.4 μm is 0.75 mL/g.

FIG. 11 is a diagram showing a pore distribution of the composite powder according to Reference Example 1.

In the composite powder of Reference Example 1, the average particle diameter D50 is 65 μm, and as shown in FIG. 11, the pore volume of pores with a pore radius of 0.055 to 0.4 μm in the powder is 0.72 mL/g. The composite powder of Reference Example 1 was rolled by roll pressing to obtain a peak pore radius of 0.1 to 0.3 μm and a pore volume of 0.61 mL/g with a pore radius of 0.055 to 0.4 μm.

Therefore, as compared with Reference Example 1, it was confirmed that in Example 1, while the cell voltage during the high humidification power generation was improved from 0.598 to 0.602 V, substantially the same cell voltage 0.620 V was maintained during the low humidification power generation.

The gas diffusion layer using the composite powder according to the present disclosure is particularly useful as a member used for a fuel cell, and can be applied to applications such as a household cogeneration system, an automobile fuel cell, a mobile fuel cell, and a backup fuel cell.

### REFERENCE SIGNS LIST

100 fuel cell
1 polymer electrolyte membrane
2 catalyst layer
2a anode catalyst layer
2b cathode catalyst layer
3 gas diffusion layer
3a anode-side gas diffusion layer
3b cathode gas diffusion layer
4 separator
4a anode side separator
4b cathode side separator
5 fluid flow path
6 rib portion
10 battery cell
11 current collecting plate
12 insulating plate
13 end plate
20 membrane electrode assembly
31 conductive particle
32 conductive fiber
33 polymer resin
40 spray freezing granulation device
41 mixed solution
42 nozzle
43 cooling chamber

What is claimed is:

1. A method for manufacturing a composite powder, the method comprising:
stirring and mixing a polymer resin and at least one or more of fibers and particles with a dispersion solvent to obtain a mixed solution of the polymer resin and at least one or more of the fibers and the particles;
spraying the mixed solution in a form of droplets into a chamber whose inside is cooled to a temperature lower than a melting point of the dispersion solvent to obtain a frozen composite powder in which the droplets are frozen; and
sublimating the dispersion solvent contained in the frozen composite powder to obtain a dried composite powder.

2. The method for manufacturing a composite powder according to claim 1, wherein the polymer resin contains polytetrafluoroethylene.

3. The method for manufacturing a composite powder according to claim 1, further comprising a step of further heating the dried composite powder at 100° C. (CelsiusDegree) or more and 400° C. (CelsiusDegree) or less.

4. A method for manufacturing a composite powder, the method comprising:
stirring and mixing a polymer resin and at least one or more of fibers and particles with a dispersion solvent to obtain a kneaded product of the polymer resin and at least one or more of fibers and particles;
freezing the kneaded product to obtain a frozen kneaded product;
pulverizing the frozen kneaded product to obtain a frozen composite powder; and
removing the dispersion solvent from the frozen composite powder to obtain a composite powder.

5. The method for manufacturing a composite powder according to claim 4, wherein a water content of the kneaded product is 20 to 80%.

6. The method for manufacturing a composite powder according to claim 4, wherein a temperature in the course of the pulverizating is −150° C. (CelsiusDegree) to −10° C. (CelsiusDegree).

7. The method for manufacturing a composite powder according to claim 4, wherein in the course of removing the dispersion solvent, the dispersion solvent contained in the frozen composite powder is sublimated to obtain a dried composite powder.

8. The method for manufacturing a composite powder according to claim 4, wherein in the course of removing the dispersion solvent, heating is further performed at 100° C. (CelsiusDegree) or more and 400° C. (CelsiusDegree) or less.

9. The method for manufacturing a composite powder according to claim 4, wherein the removing the dispersion solvent is performed by a method of evaporating moisture by heating under atmospheric pressure.

10. The method for manufacturing a composite powder according to claim 9, wherein in the course of removing the dispersion solvent, a drying temperature is 100° C. (CelsiusDegree) or more and 400° C. (CelsiusDegree) or less.

11. A method for manufacturing a composite powder, the method comprising:
stirring and mixing a polymer resin and at least one or more of fibers and particles with a dispersion solvent to obtain a kneaded product of the polymer resin and at least one or more of fibers and particles;
freezing the kneaded product to obtain a frozen kneaded product;
mixing the frozen kneaded product and the polymer resin to obtain a frozen mixture;
pulverizing the frozen mixture to obtain a frozen composite powder; and
removing the dispersion solvent from the frozen composite powder to obtain a composite powder.

12. A method for manufacturing a gas diffusion layer, the method comprising:
manufacturing a composite powder by using the method according to claim 1; and
rolling the composite powder with a roll to form a sheet, thereby obtaining a gas diffusion layer including the sheet.

13. A method for manufacturing a membrane electrode assembly, the method comprising:
manufacturing a gas diffusion layer by using the method according to claim 12;
applying the gas diffusion layer, a pair of electrodes, and an electrolyte membrane to form a membrane electrode assembly.

14. A method for manufacturing a fuel cell, the method comprising:
manufacturing a membrane electrode assembly by using the method according to claim 13; and
applying the membrane electrode assembly and a current collector plate to form a fuel cell.

15. A method for manufacturing a gas diffusion layer, the method comprising:
manufacturing a composite powder by using the method according to claim 4; and
rolling the composite powder with a roll to form a sheet, thereby obtaining a gas diffusion layer including the sheet.

16. A method for manufacturing a membrane electrode assembly, the method comprising:
manufacturing a gas diffusion layer by using the method according to claim 15;
applying the gas diffusion layer, a pair of electrodes, and an electrolyte membrane to form a membrane electrode assembly.

17. A method for manufacturing a fuel cell, the method comprising:
manufacturing a membrane electrode assembly by using the method according to claim 16; and
applying the membrane electrode assembly and a current collector plate to form a fuel cell.

18. A method for manufacturing a gas diffusion layer, the method comprising:
manufacturing a composite powder by using the method according to claim 11; and
rolling the composite powder with a roll to form a sheet, thereby obtaining a gas diffusion layer including the sheet.

19. A method for manufacturing a membrane electrode assembly, the method comprising:
manufacturing a gas diffusion layer by using the method according to claim 18;
applying the gas diffusion layer, a pair of electrodes, and an electrolyte membrane to form a membrane electrode assembly.

20. A method for manufacturing a fuel cell, the method comprising:
manufacturing a membrane electrode assembly by using the method according to claim 19; and
applying the membrane electrode assembly and a current collector plate to form a fuel cell.
